(19) United States
(12) Patent Application Publication
(10) Pub. No.: US 2018/0139614 A1
(43) Pub. Date: May 17, 2018

(54) COMMUNICATION SYSTEM, CENTRALIZED CONTROL DEVICE, INTERFERENCE CONTROL METHOD, AND INTERFERENCE CONTROL PROGRAM

(71) Applicant: SHARP KABUSHIKI KAISHA, Sakai City, Osaka (JP)

(72) Inventors: TAMOTSU SATOH, Sakai City (JP); KATSUTOSHI ISHIKURA, Sakai City (JP); HIDEAKI SHINMEI, Sakai City (JP); ATSUSHI YAMAZAKI, Sakai City (JP)

(21) Appl. No.: 15/577,459

(22) PCT Filed: May 27, 2016
(86) PCT No.: PCT/JP2016/065740

§ 371 Date: Nov. 28, 2017

(30) Foreign Application Priority Data
Jun. 1, 2015 (JP) 2015-111580

(51) Int. Cl. H04W 16/08; H04J 11/00; H04W 16/32; H04W 16/10

(52) U.S. Cl. CPC H04W 16/08; H04W 16/10; H04W 16/32; H04J 11/005

(57) ABSTRACT

A communication system includes a first base station device and a second base station device, each of which forms one or more cells, a terminal device to be connected to the cells, and a centralized control device. The centralized control device includes: an interference control unit configured to, in a case that interference between a cell formed by the first base station device and a cell formed by the second base station device is detected, suppress the interference by causing at least any one of the first base station device and the second base station device to change the formation of the cells and form a cell to which the terminal device is connectable based on a connection state prior to suppressing the interference in an area in which the interference has occurred.

### TECHNICAL FIELD

The present invention relates to a communication system, a centralized control device, an interference control method, and an interference control program.

Priority is claimed on Japanese Patent Application No. 2015-111580, filed Jun. 1, 2015, the content of which is incorporated herein by reference.

### BACKGROUND ART

A wireless communication system such as Long Term Evolution (LTE) employs a method of allocating a frequency for each cell, in which neighboring cells use the same frequency, in order to improve frequency resource utilization efficiency. In 3^{rd} Generation Partnership Project (3GPP) Release 10 (Rel. 10), inter-cell interference coordination (ICIC) is employed in order to improve throughput in an area near a cell boundary in which inter-cell interference is severe. In addition, in Rel. 11, enhanced-ICIC (eICIC) which is an extension of ICIC is employed.

Furthermore, for example, Patent Document 1 discloses a base station which forms a macro cell arranged to overlap a small cell and controls on/off of a small base station that forms the small cell.

### PRIOR ART DOCUMENT

### Patent Document

[Patent Document 1]

Japanese Unexamined Patent Application, First Publication No. 2015-33015

### SUMMARY OF THE INVENTION

### Problem to be Solved by the Invention

In the technology disclosed in Patent Document 1, occurrence of inter-cell interference due to overlap of regions in the macro cell and the small cell is avoided by performing power on/off control of the small base station. However, when interference avoidance is performed through power on/off of the small base station, the number of cells decreases. Accordingly, there were cases in which the amount of data transmission/reception (performance and total throughput) was reduced depending on the number of terminals connected to cells from the viewpoint of the entire system.

Several aspects of the present invention devised to solve the problem provide a communication system, a centralized control device, an interference control method, and an interference control program which can suppress a decrease in the amount of data transmission/reception when inter-cell interference has occurred.

### Means for Solving the Problems

The present invention is made to solve the above-described problem, and one aspect of the present invention is a communication system including a first base station device and a second base station device, each of which forms one or more cells, a terminal device to be connected to the cells, and a centralized control device, wherein the centralized control device includes: an interference control unit configured to, in a case that interference between a cell formed by the first base station device and a cell formed by the second base station device is detected, suppress the interference by causing at least any one of the first base station device and the second base station device to change the formation of the cells and form a cell to which the terminal device is connectable based on a connection state prior to suppressing the interference in an area in which the interference has occurred.

In addition, one aspect of the present invention is a centralized control device communicating with a first base station device and a second base station device, each of which forms one or more cells, and a terminal device to be connected to the cells, the centralized control device including: an interference control unit configured to, in a case that interference between a cell formed by the first base station device and a cell formed by the second base station device is detected, suppress the interference by causing at least any one of the first base station device and the second base station device to change the formation of the cells and form a cell to which the terminal device is connectable based on a connection state prior to suppressing the interference in an area in which the interference has occurred.

In addition, one aspect of the present invention is an interference control method in a centralized control device communicating with a first base station device and a second base station device, each of which forms one or more cells, and a terminal device to be connected to the cells, the interference control method including: in a case that interference between a cell formed by the first base station device and a cell formed by the second base station device is detected, suppressing the interference by causing at least any one of the first base station device and the second base station device to change the formation of the cells and form a cell to which the terminal device is connectable based on a connection state prior to suppressing the interference in an area in which the interference has occurred.

In addition, one aspect of an interference control program for causing a computer of a centralized control device communicating with a first base station device and a second base station device, each of which forms one or more cells, and a terminal device to be connected to the cells to execute: in a case that interference between a cell formed by the first base station device and a cell formed by the second base station device is detected, suppressing the interference by causing at least any one of the first base station device and the second base station device to change the formation of the cells and form a cell to which the terminal device is connectable based on a connection state prior to suppressing the interference in an area in which the interference has occurred.

### Effect of the Invention

According to several aspects of the present invention, it is possible to suppress a decrease in the amount of data transmission/reception when inter-cell interference has occurred.

### BRIEF DESCRIPTION OF THE DRAWINGS

FIG. 1 is a first schematic diagram illustrating an overview of a communication system according to a first embodiment of the present invention.

FIG. 2 is a second schematic diagram illustrating an overview of the communication system according to the present embodiment.

FIG. 3 is a block diagram illustrating a schematic functional configuration of a centralized control device according to the embodiment.

FIG. 4 is a schematic diagram illustrating an overview of eICIC according to the embodiment.

FIG. 5 is a schematic diagram illustrating an overview of component carrier allocation according to the embodiment.

FIG. 6 is a block diagram illustrating a schematic functional configuration of a macro-cell base station device according to the embodiment.

FIG. 7 is a block diagram illustrating a schematic functional configuration of a small-cell base station device according to the embodiment.

FIG. 8 is a block diagram illustrating a schematic functional configuration of a terminal device according to the embodiment.

FIG. 9 is a block diagram illustrating a hardware configuration of a computer system according to the embodiment.

FIG. 10 is a flowchart illustrating an example of a processing flow executed by the centralized control device according to the embodiment.

FIG. 11 is a diagram illustrating an overview of a simulation condition of interference control performed by a centralized control device according to a second embodiment of the present invention.

FIG. 12 is a first diagram illustrating a simulation result of interference control performed by the centralized control device according to the embodiment.

FIG. 13 is a second diagram illustrating a simulation result of interference control performed by the centralized control device according to the embodiment.

FIG. 14 is a flowchart illustrating an example of a processing flow executed by the centralized control device according to the embodiment.

### EMBODIMENTS FOR CARRYING OUT THE INVENTION

### First Embodiment

### [Configuration of Communication System]

Hereinafter, embodiments of the present invention will be described with reference to the drawings.

A communication system 1 according to the present embodiment is a system which provides a communication service according to a heterogeneous network using a macro cell and a small cell formed inside of the macro cell and is provided with carrier aggregation. Specifically, the communication system 1 provides a communication service using LTE or LTE-Advanced. Carrier aggregation is a technique of simultaneously operating radio waves (component carriers) of a plurality of different frequency bands, and distributively transmitting/receiving data through one communication line to achieve stabilized high-speed communication.

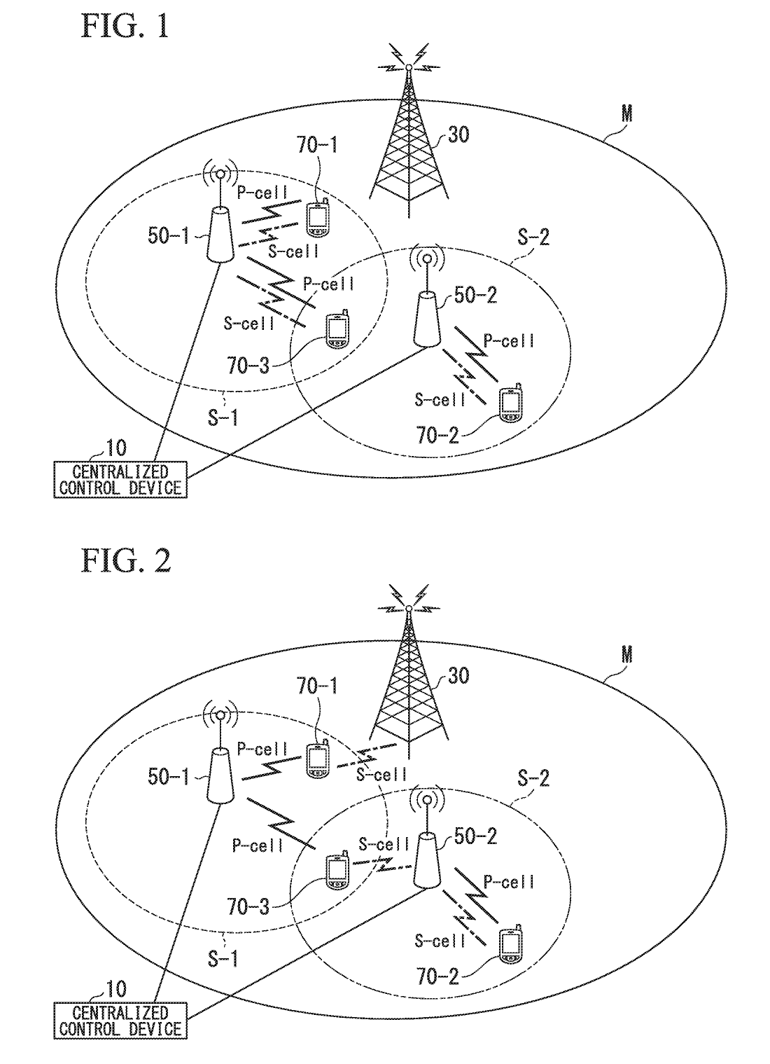

FIGS. 1 and 2 are schematic diagrams illustrating overviews of the communication system l according to the present embodiment.

The communication system 1 according to the present embodiment includes a centralized control device 10, a macro-cell base station device 30, a small-cell base station device 50, and a terminal device 70. The communication system 1 may include a plurality of centralized control devices, a plurality of macro-cell base station devices, a plurality of small-cell base station devices, and a plurality of terminal devices. The centralized control device 10, the macro-cell base station device 30, and the small-cell base station device 50 may be connected to a backbone network to communicate with one another. Hereinafter, the macro-cell base station device 30 and the small-cell base station device 50 will be collectively called simply a base station device when they are not particularly discriminated from each other.

The centralized control device 10 is a device which controls formation of cells by the macro-cell base station device 30 and the small-cell base station device 50. For example, the centralized control device 10 is a device such as a control server, a gateway (HeNodeB GW or the like), or the like.

The macro-cell base station device 30 is a base station device which forms a macro cell M. The macro cell M is a communication area of a relatively wide range (e.g., a radius of several hundred meters to several kilometers). For example, the macro-cell base station device 30 may form a plurality of macro cells M according to different component carriers.

The small-cell base station device 50 is a base station device which forms a small cell S. The small cell S is a communication area of a relatively narrow range. The small cell S includes a micro cell having a coverage area radius of tens of meters to hundreds of meters, a pico cell (also referred to as a nano cell) having a coverage area radius of several meters to tens of meters, and a femto cell having a coverage area radius of tens of centimeters to several meters. For example, the small-cell base station device 50 may form a plurality of small cells S according to different component carriers.

The terminal device 70 is an electronic apparatus which communicates with other devices through any one or both of the macro cell M and the small cell S, or a plurality of small cells S. The terminal device 70 may perform communication through a plurality of cells. Hereinafter, a plurality of cells used by the terminal device 70 will be divided into a primary cell and a secondary cell and described. The primary cell is a cell for which the terminal device 70 maintains connection to accept frequency band allocation and timing (scheduling) control, among cells formed by the macro-cell base station device 30 or the small-cell base station device 50. The primary cell is also called a primary component carrier. The secondary cell is a cell to which the terminal device 70 is additionally connected, among cells formed by the macro-cell base station device 30 or the small-cell base station device 50. The secondary cell is also called a secondary component carrier.

One primary cell is set for each terminal device 70, whereas one or more secondary cells may be set for each terminal device 70. Hereinafter, the primary cell will be referred to as a P-cell and the secondary cell will be referred to as an S-cell. Meanwhile, in the communication system 1, occurrence of interference is suppressed between P-cells formed by each base station device according to so-called eICIC. eICIC will be described below.

Next, an overview of interference control according to the communication system 1 will be described.

In an example illustrated in FIG. 1, two small-cell base station devices 50-1 and 50-2 are located in the macro cell M formed by the macro-cell base station device 30. In such a heterogeneous network, the small cell S exists in the macro cell M and thus interference may occur between the macro cell M and the small cell S. In addition, in the example illustrated in FIG. 1, a small cell S-1 and a small cell S-2 partially overlap. Accordingly, interference may occur between the small cell S-1 and the small cell S-2. In addition, there are cases in which interference occurs due to radio waves emitted from an external device of the communication system 1.

When interference has occurred, communication quality deteriorates and the amount of data transmission/reception decreases, which is not desirable. Accordingly, the centralized control device 10 according to the present embodiment controls formation of cells by the macro-cell base station device 30 and the small-cell base station devices 50-1 and 50-2 to suppress the interference.

In the example illustrated in FIG. 1, a terminal device 70-1 is located in the small cell S-1 and uses cells formed by the small-cell base station device 50-1 as a P-cell and an S-cell. In addition, a terminal device 70-2 is located in the small cell S-2 and uses cells formed by the small-cell base station device 50-2 as a P-cell and an S-cell. A terminal device 70-3 is located in an overlap area of the small cell S-1 and the small cell S-2 and uses cells formed by the small-cell base station device 50-1 as a P-cell and an S-cell.

When the terminal devices 70-1 and 70-3 use an S-cell of the same component carrier, if interference occurs in the S-cell, the communication system 1 switches connection destinations of the terminal devices 70, as illustrated in FIG. 2. Specifically, the terminal devices 70-1 and 70-3 hand over from the S-cell in which interference has occurred to other cells. For example, the terminal device 70-1 is located in the macro cell M and thus executes handover to the macro-cell base station device 30. In addition, the terminal device 70-2 is located in the overlap area of the small cells S50-1 and S50-2 and thus executes handover to the small-cell base station device 50-2. On the other hand, the terminal devices 70-1 and 70-3 maintain connection to the P-cell. In addition, the centralized control device 10 controls the small-cell base station device 50-1 to suspend the formation of the S-cell in which interference has occurred to put the S-cell in an OFF state. In this manner, the communication system 1 puts only the S-cell in an OFF state while maintaining connection to the P-cell When interference has occurred. Then, the communication system 1 re-sets another cell as an S-cell. Here, an S-cell may not be re-set for a terminal device which uses only a P-cell.

As described above, the communication system 1 includes the macro-cell base station device 30 and the small-cell base station device 50 which form one or more cells, the terminal device 70 connected to cells, and the centralized control device 10. In the communication system 1, the centralized control device 10 detects interference between cells formed by each base station device such as the macro-cell base station device 30 and the small-cell base station device 50. In addition, the centralized control device 10 suppresses interference by causing at least any one of base station devices which form cells related to interference to change the formation of the cells and form a cell to which the terminal device 70 can be connected depending on a utilization state in an area in which interference has occurred. In the case of the example illustrated in FIG. 2, the centralized control device 10 suspends the formation of an S-cell by the small-cell base station device 50-1 and causes the macro-cell base station device 30 to form a cell to which the terminal device 70-1 can be connected. This cell may be formed before the interference is suppressed.

Accordingly, the communication system 1 can suppress inter-cell interference and the terminal device 70 can secure a connection destination in an area in which interference has occurred. Accordingly, the communication system 1 can avoid inter-cell interference while suppressing deterioration of total throughput of the system because the communication system 1 does not perform power off of a small-cell base station device, which is a conventional inter-cell interference avoidance technique.

### [Configuration of Centralized Control Device]

Next, a configuration of each device included in the communication system 1 will be described.

First, a configuration of the centralized control device 10 will be described.

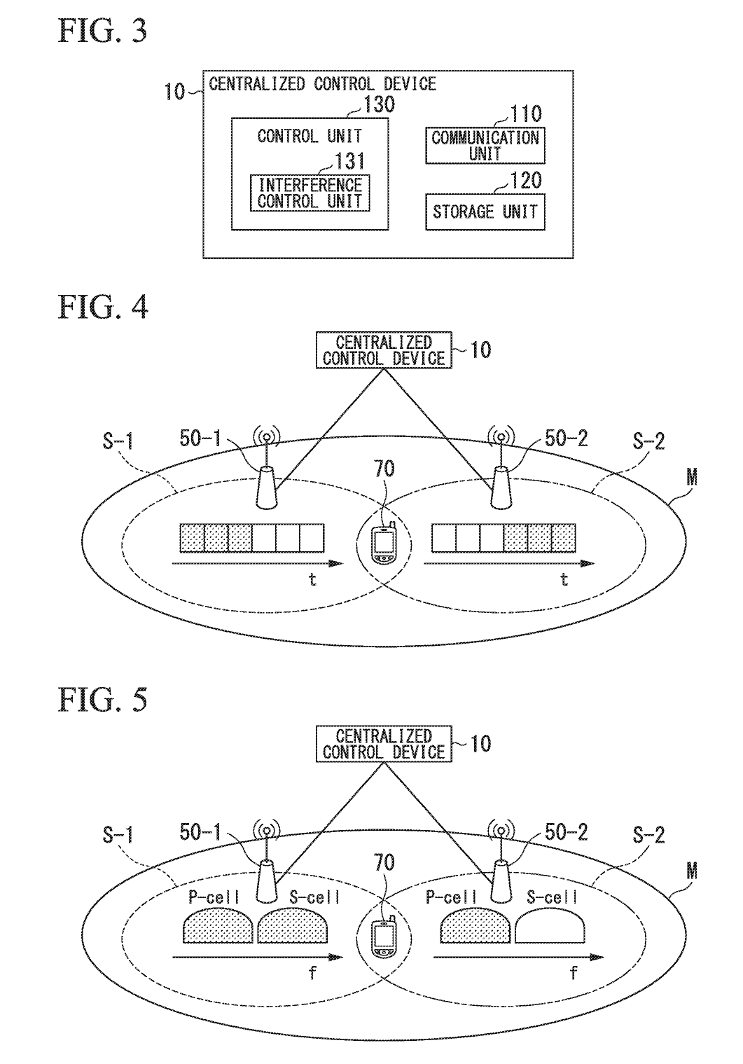

FIG. 3 is a block diagram illustrating a schematic functional configuration of the centralized control device 10 according to the present embodiment.

The centralized control device 10 includes a communication unit 110, a storage unit 120, and a control unit 130.

The communication unit 110 communicates with the macro-cell base station device 30 and the small-cell base station device 50 through a backbone network.

The storage unit 120 stores various types of data used for each unit of the centralized control device 10, data generated according to the operation of each unit of the centralized control device 10, and software for operating the centralized control device 10.

The control unit 130 controls each unit included in the centralized control device 10. In addition, the control unit 130 includes an interference control unit 131.

The interference control unit 131 acquires interference notification information representing occurrence of interference from the terminal device 70 through the macro-cell base station device 30 or the small-cell base station device 50. The interference control unit 131 can recognize detection of interference in the terminal device 70 by acquiring the interference notification information. When the interference notification information is acquired, the interference control unit 131 performs an interference control process depending on the type of an interfering cell.

For example, when interference has occurred in a P-cell, the interference control unit 131 suppresses the interference using eICIC. On the other hand, when interference has occurred in an S-cell, the interference control unit 131 requests that the macro-cell base station device 30 or the small-cell base station device 50 which forms the S-cell suspend the formation of the S-cell and put the S-cell in an OFF state. For example, when S-cells interfere each other, the interference control unit 131 selects an S-cell to put in an OFF state depending on connection states of other terminal devices 70 for each S-cell, a communication state, and a state of a neighboring base station device (cell). For example, the interference control unit 131 acquires communication states of the terminal devices 70 connected to two S-cells and puts an S-cell having a lower communication load in an OFF state. In addition, the interference control unit 131 requests that the terminal device 70 connected to the S-cell in the OFF state hand over to another cell. Here, when there is no cell to which the terminal device 70 can hand over, the centralized control device 10 may cause the macro-cell base station device 30 or the small-cell base station device 50 to put a cell which is estimated to be a cell in which interference does not occur, for example, a cell which has been put in an OFF state in advance, in an ON state to newly form the cell.

Meanwhile, the OFF state is a state in which an output voltage of transmitted waves is suppressed to be a predetermined value or lower.

On the other hand, the ON state is a state in which transmitted waves are transmitted at an output voltage equal to or higher than a predetermined value to torn a cell.

Here, the interference control process performed by the interference control unit 131 will be described.

FIG. 4 is a schematic diagram illustrating an overview of eICIC according to the present embodiment.

The example of FIG. 4 illustrates eICIC between small cells S-1 and S-2 which overlap. The same component carrier is allocated to the small cells S-1 and S-2. Subframes corresponding to the time axis t indicated in each cell represent a time schedule related to allocation of almost blank subframes (ABSs) per unit time. In six subframes of each cell illustrated in FIG. 4, non-ABSs are allocated to three subframes of the former half and ABSs are allocated to three subframes of the latter half with respect to the small cell S-1. In addition, ABSs are allocated to three subframes of the former half and non-ABSs are allocated to three subframes of the latter half with respect to the small cell S-2. That is, the small cell S-1 becomes valid in the first three subframes and the small cell S-2 becomes valid in the latter three subframes. In this manner, eICIC can suppress occurrence of interference by shifting a timing at which a cell becomes valid even when the same component carrier is used in overlapping cells.

Meanwhile, the communication system 1 may employ eICIC and ICIC of any type. For example, the communication system 1 may form cells using different component carriers between neighboring cells to suppress inter-cell interference. In addition, the communication system 1 may employ, for example, semi-static eICIC which uses an ABS pattern fixed for a relatively long time or dynamic eICIC which changes ABS patterns on the order of several hundred milliseconds in response to traffic.

FIG. 5 is a schematic diagram illustrating an overview of component carrier allocation according to the present embodiment.

In the example illustrated in FIG. 5, each block corresponding to the frequency base f indicated in each cell represents allocation of component carriers to a P-cell and an S-cell. In the small cells S-1 and S-2 which overlap with each other, the same component carriers are used as a P-cell and an S-cell. However, interference does not occur between P-cells according to eICIC illustrated in FIG. 4. On the other hand, interference may occur between S-cells, and thus the S-cell of the small cell S-2 is in an OFF state. Accordingly, interference between S-cells is avoided. Further, in this case, the terminal device 70 located in the overlap area of the small cells S-1 and S-2 can be connected to the small cell S-1, preventing throughput decrease.

### [Configuration of Base Station Device]

Next, configurations of the macro-cell base station device 30 and the base station device 50 will be described.

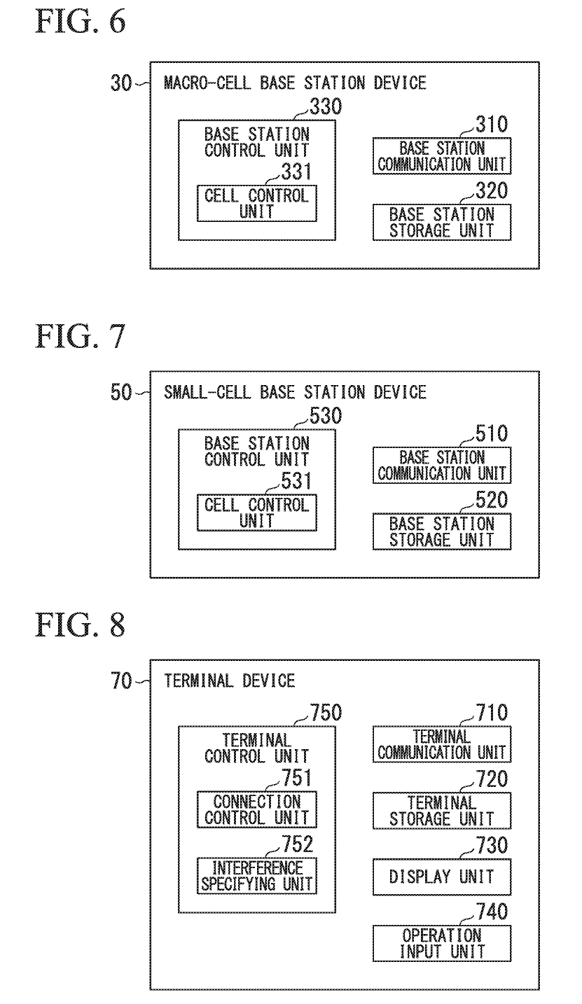

FIG. 6 is a block diagram illustrating a schematic functional configuration of the macro-cell base station device 30 according to the present embodiment.

The macro-cell base station device 30 includes a base station communication unit 310, a base station storage unit 320, and a base station control unit 330.

The base station communication unit 310 receives radio waves transmitted from the terminal device 70, demodulates the received radio waves of a wireless band into a received signal of a baseband, and outputs the received signal to each unit of the macro-cell base station device 30. In addition, the terminal communication unit 710 modulates a transmitted signal of a baseband input from each unit of the macro-cell base station device 30 into transmitted waves of a wireless band and transmits the modulated transmitted waves to other devices through an antenna. Accordingly, the base station communication unit 310 forms a cell and communicates with the terminal device 70. In addition, the base station communication unit 310 communicates with the centralized control device 10 and other base station devices through a backbone network.

The base station storage unit 320 stores various types of data used for each unit of the macro-cell base station device 30, data generated according to the operation of each unit of the macro-cell base station device 30, and software for operating the macro-cell base station device 30.

The base station control unit 330 performs management and control of the overall operation of the macro-cell base station device 30.

In addition, the base station control unit 330 includes a cell control unit 331.

The cell control unit 331 controls ON/OFF states of a cell and controls communication with the terminal device 70. For example, the cell control unit 331 executes a process related to establishment of connection with the terminal device 70 or disconnection from the terminal device 70. In addition, the cell control unit 331 allocates a resource block (RB) used for transmission and reception of data between the macro-cell base station device 30 and the terminal device 70 using an unused frequency band on the basis of quality information received from the terminal device 70. The RB is a minimum unit of radio resources used for data transmission and reception, that is, a unit bandwidth (e.g., 180 kHz) in a unit time (e.g., 1 ms). The quality information is information which represents reception quality of each RB, for example, channel quality indicator (CQI). For example, the cell control unit 331 controls a handover process for switching a connection destination of the terminal device 70 connected to the macro-cell base station device 30 from the macro-cell base station device 30 to another base station device or switching a connection destination of the terminal device 70 connected to another base station device from the other base station device to the macro-cell base station device 30.

The cell control unit 331 receives interference notification information representing occurrence of interference from the terminal device 70 through the base station control unit 330. The cell control unit 331 outputs the acquired interference notification information to the centralized control device 10.

The cell control unit 331 controls a cell state in response to a request from the centralized control device 10.

For example, the cell control unit 331 controls transmission of transmitted waves to the terminal device 70 with respect to an S-cell in which interference has occurred to put the S-cell in an OFF state.

FIG. 7 is a block diagram illustrating a schematic functional configuration of the small-cell base station device 50 according to the present embodiment.

The small-cell base station device 50 includes a base station communication unit 510, a base station storage unit 520, and a base station control unit 530 instead of the base station communication unit 310, the base station storage unit 320, and the base station control unit 330 included in the macro-cell base station device 30. The base station communication unit 510, the base station storage unit 520, and the base station control unit 530 are the same as the base station communication unit 310, the base station storage unit 320, and the base station control unit 330 and thus description thereof is omitted.

### [Configuration of Terminal Device]

FIG. 8 is a block diagram illustrating a schematic functional configuration of a terminal device according to the present embodiment.

The terminal device 70 includes a terminal communication unit 710, a terminal storage unit 720, a display unit 730, an operation input unit 740, and a terminal control unit 750.

The terminal communication unit 710 receives radio waves transmitted from the macro-cell base station device 30 and the small-cell base station device 50, demodulates the received radio waves of a wireless band into a received signal of a baseband, and outputs the received signal to each unit of the terminal device 70. In addition, the terminal communication unit 710 modulates a transmitted signal of a baseband input from each unit of the terminal device 70 into transmitted waves of a wireless band and transmits the modulated transmitted waves to other devices through an antenna. Accordingly, the terminal communication unit 710 can perform communication through a cell formed by the macro-cell base station device 30 or the small-cell base station device 50.

The terminal storage unit 720 stores various types of data used for each unit of the terminal device 70, data generated according to the operation of each unit of the terminal device 70, and software for operating the terminal device 70.

The display unit 730 includes a display device, for example, a liquid crystal display, an organic electro-luminescence (EL) display and the like.

The operation input unit 740 receives an input from a user. For example, the operation input unit 740 includes an input device, for example, a mouse, a keyboard, a touch panel, or the like.

The terminal control unit 750 performs management and control of the overall operation of the terminal device 70. In addition, the terminal control unit 750 includes a connection control unit 751 and an interference specifying unit 732.

The connection control unit 751 controls communication between the macro-cell base station device 30 and the small-cell base station device 50. For example, the connection control unit 751 performs a process of selecting a cell used as a P-cell and a cell used as an S-cell from cells to Which the terminal communication unit 710 can be connected. In addition, the connection control unit 751 executes a process related to establishment of connection to a macro cell M and a small cell S or disconnection therefrom. Further, the connection control unit 751 measures reception quality of each RB with respect to the macro cell M and the small cell S and generates quality information representing the measured reception quality, for example, CQI.

The connection control unit 751 transmits the generated quality information to the macro cell M and the small cell S through the terminal communication unit 710.

The interference specifying unit 732 detects the occurrence of interference on the basis of reception states of transmitted waves from the macro-cell base station device 30 and the small-cell base station device 50. For example, the interference specifying unit 732 compares reference signal received quality (RSRQ) of each RB with a predetermined RSRQ threshold value and determines the occurrence of interference for a signal received by the terminal communication unit 710. The RSRQ is a ratio of reference signal received power (RSRP) to a received signal strength indicator (RSSI) of the entire system band. When interference is detected, the interference specifying unit 732 transmits interference notification information to the centralized control device 10 through the macro-cell base station device 30 or the small-cell base station device 50.

### [Hardware Configuration of Computer System]

Each of the above-described devices includes a computer system. An example of a hardware configuration of a computer system included in each device will be described.

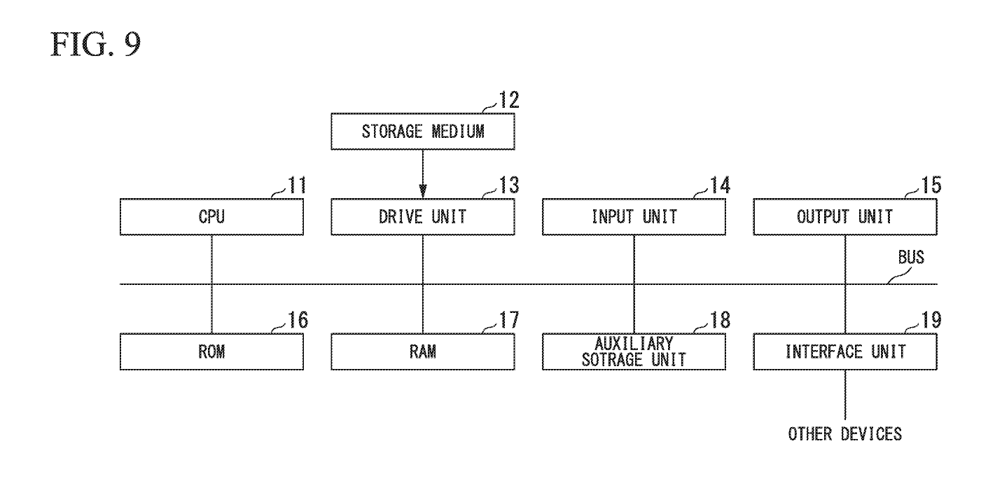

FIG. 9 is a block diagram illustrating a hardware configuration of a computer system according to the present embodiment.

The computer system according to the present embodiment includes a central processing unit (CPU) 11, a storage medium 12, a drive unit 13, an input unit 14, an output unit 15, a read only memory (ROM) 16, a RAM 17, an auxiliary storage unit 18, and an interface unit 19.

The CPU 11, drive unit 13, input unit 14, output unit 15, ROM 16, random access memory (RAM) 17, auxiliary storage unit 18, and interface unit 19 are connected through a bus (bus line).

The CPU 11 reads programs and various types of data to control each unit of the computer system and realizes the aforementioned various functional units. The storage medium 12 is a portable storage medium, for example, a magneto-optical disc, a flexible disk, a flash memory or the like, and stores various types of data, for example. For example, the drive unit 13 is a read device or a write device of the storage medium 12. The input unit 14 is an input device, for example, a mouse, a keyboard or the like. The output unit 15 is an output device, for example, a display unit, a speaker or the like. The ROM 16 is a storage medium which stores programs, for example. The RAM 17 is a storage medium which temporarily stores various types of data and programs, for example. The auxiliary storage unit 18 is a storage medium such as a hard disk drive (HDD) and a flash memory and, for example, stores various types of data. The interface unit 19 has an interface for communication and performs wired or wireless communication with other devices. Programs read by the CPU 11 may be stored in the storage medium 12 and the auxiliary storage unit 18 in addition to the ROM 16, and programs downloaded from other devices may be stored in the storage medium 12, the auxiliary storage unit 18 and the like. Various types of data read by the CPU 11 may be stored in the ROM 16 in addition to the storage medium 12 and the auxiliary storage unit 18 and may be downloaded from other devices.

### [Operation of Centralized Control Device]

Next, the operation of the centralized control device 10 will be described.

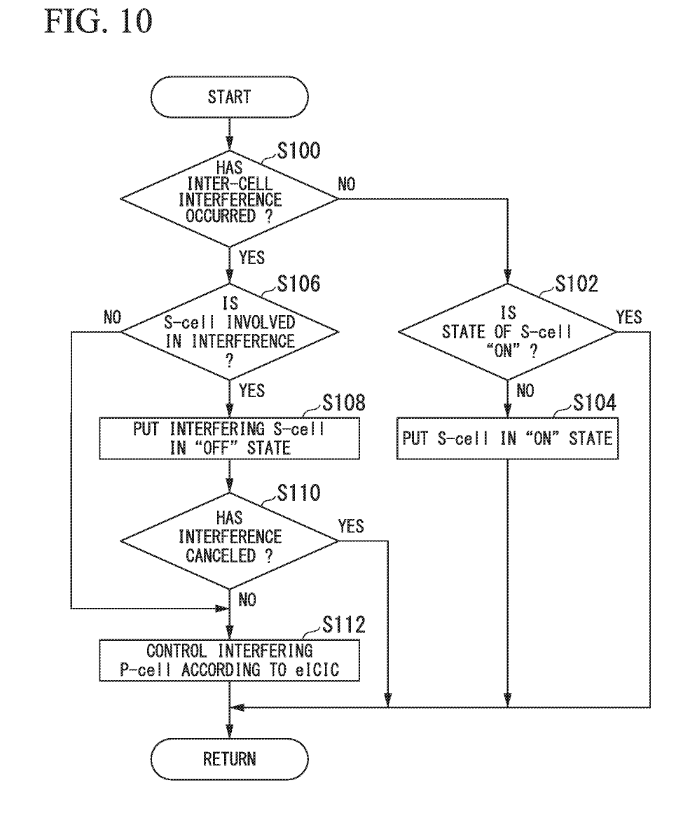

FIG. 10 is a flowchart illustrating an example of a processing flow executed by the centralized control device 10 according to the present embodiment.

(Step S100) The centralized control device 10 determines whether interference has occurred between cells. When interference has not occurred (NO in step S100), the centralized control device 10 advances the process to step S102. When interference has occurred (YES in step S100), the centralized control device 10 advances the process to step S106.

(Step S102) The centralized control device 10 determines whether an S-cell is in an ON state.

When the S-cell is not in an ON state, that is, when the S-cell is in an OFF state (NO in step S102), the centralized control device 10 advances the process to step S104. When the S-cell is in an ON state (YES in step S102), the centralized control device 10 advances the process to step S100.

(Step S104) The centralized control device 10 puts the S-cell in an ON state. Then, the centralized control device 10 returns the process to step S100.

(Step S106) The centralized control device 10 determines whether the S-cell is subjected to interference. When the S-cell is subjected to interference (YES in step S106), the centralized control device 10 advances the process to step S108. When the S-cell is not subjected to interference, that is, when the P-cell is subjected to interference (NO in step S106), the centralized control device 10 advances the process to step S112.

(Step S108) The centralized control device 10 puts the S-cell subjected to interference in an OFF state. Then, the centralized control device 10 advances the process to step S110.

(Step S110) The centralized control device 10 determines whether the interference has been canceled. When the interference has been canceled (YES in step S110), the centralized control device 10 returns the process to step S100. When the interference has not been canceled (NO in step S110), the centralized control device 10 advances the process to step S112.

(Step S112) The centralized control device 10 suppresses interference in a P-cell subjected to interference according to eICIC. Then, the centralized control device 10 returns the process to step S100.

### Summary of the First Embodiment

As described above, the communication system 1 according to the present embodiment includes a first base station device (e.g., the macro-cell base station device 30) and a second base station device (e.g., the small-cell base station device 50) each of which forms one or more cells, the terminal device 70 which is connected to cells, and a centralized control device 10, wherein the centralized control device 10 includes the interference control unit 131 which, when interference is detected between a cell formed by the first base station device and a cell formed by the second base station device, suppresses the interference by causing at least any one of the first base station device and the second base station device to change the formation of cells and form a cell to which the terminal device 70 can be connected on the basis of a connection state before the interference is suppressed in an area in which the interference has occurred.

Accordingly, when inter-cell interference has occurred, the communication system 1 provides a cell to which the terminal device 70 can be connected while suppressing the interference and thus does not seriously obstruct data transmission and reception of the terminal device 70. Accordingly, the communication system 1 can suppress a decrease in the amount of data transmission/reception when inter-cell interference has occurred.

In addition, the interference control unit 131 suppresses interference by changing frequencies of at least part of cells in which interference has been detected.

Further, the interference control unit 131 suppresses interference by changing allocation of frequencies of at least part of cells in which interference has been detected in the time axis.

Accordingly, when interference has been detected between P-cells, for example, the communication system 1 can suppress the interference according to eICIC, ICIC and the like.

In addition, the interference control unit 131 suppresses interference by suspending formation of at least part of cells in which interference has been detected.

Accordingly, when interference according to an S-cell has been detected, for example, the communication system 1 can suppress the interference by putting the S-cell in an OFF state.

### Second Embodiment

A second embodiment of the present invention will be described. In the present embodiment, the same components as those of the above-described first embodiment are referred to by the same signs and description thereof is as cited. A communication system 1A (not shown) according to the present embodiment provides communication according to a heterogeneous network like the communication system 1 according to the first embodiment. However, the communication system 1A differs from the first embodiment in that the communication system 1A has a function of putting a cell subjected to interference in an ON state depending on a communication service utilization state even when inter-cell interference has occurred. The communication system 1A includes a centralized control device 10A (not shown) instead of the centralized control device 10 according to the first embodiment and the centralized control device 10A controls an ON state and an OFF state of a cell, for example.

Here, the background of processing of the communication system 1A will be described using a simulation based on the indoor evaluation model (ITU-R indoor hotspot) of 3GPP.

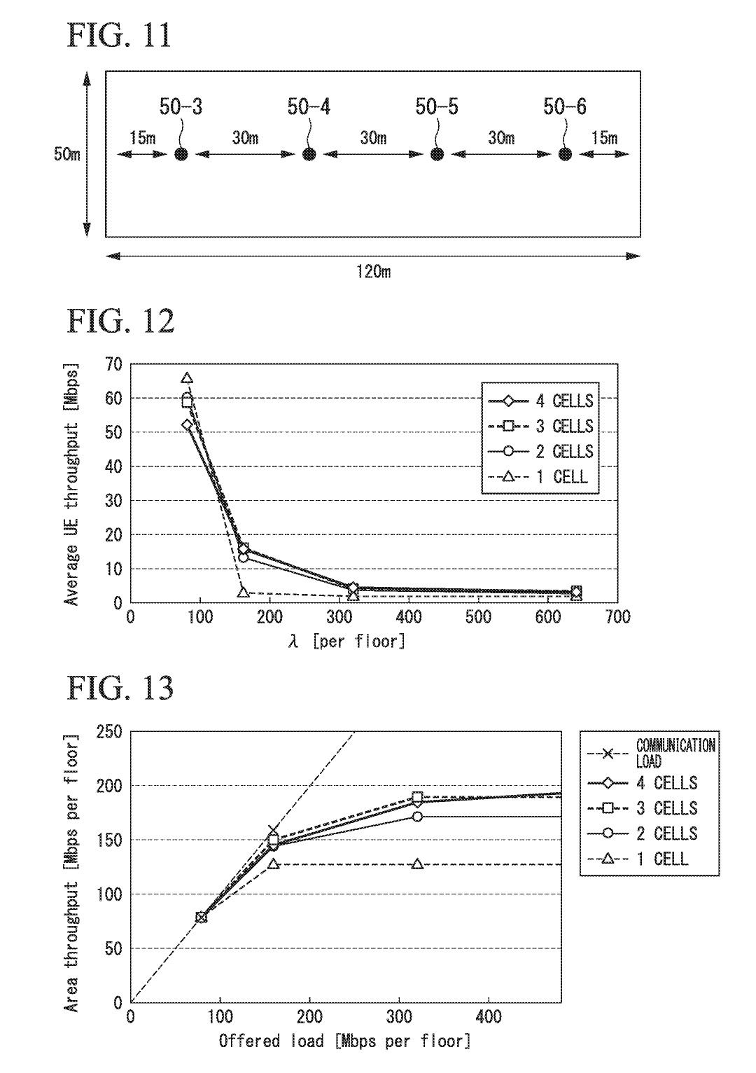

FIG. 11 is a diagram illustrating an overview of a simulation condition of interference control performed by the centralized control device 10 according to the present embodiment.

In the simulation condition illustrated in FIG. 11, four small-cell base station devices 50-1, 50-2, 50-3 and 50-4 are arranged at equal intervals in the horizontal direction at the center of the vertical direction in a space (floor) having an area with a vertical length of 50 m and a horizontal length of 120 m. Each small-cell base station device 50 forms one P-cell and puts one S-cell in any one of ON/OFF states.

FIG. 12 is a first diagram illustrating a simulation result of interference control performed by the centralized control device 10A according to the present embodiment.

In FIG. 12, the horizontal axis represents the number of terminal devices 70 on the floor and the vertical axis represents the average throughput of each terminal device 70. In addition, each line on the graph represents a change depending on the number of S-cells. Referring to FIG. 12, it can be confirmed that the average throughput of each terminal device 70 increases when the number of S-cells in the ON state is small in a case in which the number of terminal devices 70 is small, that is, about 100 to 130. On the other hand, when the number of terminal devices 70 is about 300 or more, there is no large difference between the average throughputs of the terminal devices 70 irrespective of the number of S-cells in the ON state.

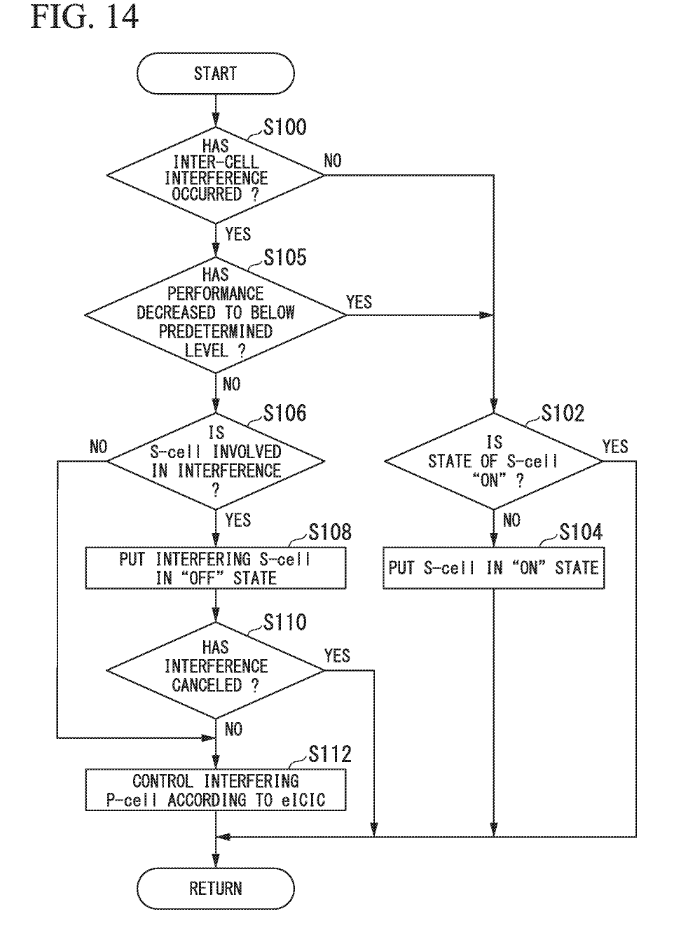

FIG. 13 is a second diagram illustrating a simulation result of interference control performed by the centralized control device 10A according to the present embodiment.

In FIG. 13, the horizontal axis represents the magnitude of communication loads of all terminal devices 70 on the floor and the vertical axis represents the magnitude of throughputs (total throughput) of all terminal devices 70 on the floor, In addition, each line on the graph represents a change depending on the number of S-cells. Referring to FIG. 13, when there are 100 or more terminal devices 70 on the floor, it can be confirmed that the throughput of all of the terminal devices 70 increases depending on the number of S-cells. When there is a communication load beyond a certain level in this way, the amount of data transmission reception of the entire system increases when the number of S-cells in the ON state increases even when communication quality of the S-cells deteriorates due to interference. Accordingly, the communication system 1A puts S-cells in the OFF state in order to suppress interference when a communication load is low and puts the S-cells in the ON state even if interference has occurred when the communication load is high.

Accordingly, it is possible to optimize the throughput of the entire system and the throughput of each terminal device 70.

Next, the operation of the centralized control device 10A according to the present embodiment will be described.

FIG. 14 is a flowchart illustrating an example of a processing flow executed by the centralized control device 10A according to the present embodiment.

In the processes illustrated in FIG. 14, the same processes as the processes illustrated in FIG. 10 are referred to by the same signs and description thereof is omitted.

(Step S105) When inter-cell interference has occurred in step S100 (YES in step S100), the centralized control device 10 determines whether the performance (total throughput) of the communication system 1 has decreased to below a predetermined level. When the performance has decreased to below the predetermined level (YES in step S105), the centralized control device 10 proceeds the process to step S102. On the other hand, when the performance corresponds to or exceeds the predetermined level (NO in step S105), the centralized control device 10A proceeds to step S106.

As described above, the interference control unit 131 of the centralized control device 10A according to the present embodiment cancels suspension of formation of cells on the basis of connection states of a plurality of terminal devices 70 with respect to cells.

Accordingly, the communication system 1A can suppress a decrease in the amount of data transmission/reception in the entire system. For example, connection states of terminal devices 70 with respect to cells include the number of connections of terminal devices 70, total throughput, a communication load, a requested data quantity, a data transfer rate, etc.

Meanwhile, the configurations of the devices included in the communication systems 1 and 1A may be arbitrarily separated, combined and included in other devices. For example, in each of the above-described embodiments, occurrence of interference may be detected by a device other than the terminal device 70. In this case, the centralized control devices 10 and 10A, the macro-cell base station device 30 or the small-cell base station device 50 may acquire information necessary to detect interference, such as RSRP for each RB, from the terminal device 70 to detect occurrence of interference. In addition, each component included in the centralized control device 10 may be included in the macro-cell base station device 30, for example.

Furthermore, although a case in which interference occurs between a macro cell M and a small cell S has been described in each of the aforementioned embodiments, the present invention is not limited thereto. The communication system 1 may perform the aforementioned control for interference between macro cells M, interference between small cells S, and interference according to an external interference source.

Further, part of or all of the centralized control devices 10 and 10A, the macro-cell base station device 30, the small-cell base station device 50, and the terminal device 70 in the above-described embodiments may be realized as an integrated circuit such as Large Scale Integration (LSI). The functional blocks of the centralized control devices 10 and 10A, the macro-cell base station device 30, the small-cell base station device 50, and the terminal device 70 may be individually configured as processors, or some or all of the functional blocks may be integrated into a processor. In addition, integration techniques are not limited to LSI and the devices may be realized as dedicated circuits or general-purpose processors. Further, when an integration technology which replaces LSI appears with the advancement of semiconductor technology, integrated circuits according to the technology may be used.

Although an embodiment of the present invention has been described in detail with reference to the drawings, a specific configuration is not limited to the embodiments and various modifications can be made in the present invention without departing from the spirit of the invention.

### INDUSTRIAL APPLICABILITY

Several aspects of the present invention can be applied to a communication system, a centralized control device, an interference control method, an interference control program and the like which require suppressing deterioration of the entire performance when inter-cell interference has occurred.

### DESCRIPTION OF THE REFERENCE SYMBOLS

1 Communication system

10 Centralized control device

30 Macro-cell base station device

50 Small-cell base station device

70 Terminal device

1. A communication system comprising a first base station device and a second base station device, each of which forms one or more cells, a terminal device to be connected to the cells, and a centralized control device,
wherein the centralized control device comprises:
an interference control unit configured to, in a case that interference between a cell formed by the first base station device and a cell formed by the second base station device is detected, suppress the interference by causing at least any one of the first base station device and the second base station device to change the formation of the cells and form a cell to which the terminal device is connectable based on a connection state prior to suppressing the interference in an area in which the interference has occurred.

2. The communication system according to claim 1,
wherein the interference control unit is configured to suppress the interference by changing the frequency of at least part of the cells in which the interference is detected.

3. The communication system according to claim 1,
wherein the interference control unit is configured to suppress the interference by changing allocation of the frequency of at least part of the cells in which the interference is detected in a time axis.

4. The communication system according to claim 1,
wherein the interference control unit is configured to suppress the interference by suspending formation of at least part of the cells in which the interference is detected.

5. The communication system according to claim 1,
wherein the interference control unit is configured to cancel suspension of the formation of the cells based on connection states of a plurality of terminal devices with respect to the cells.

6. A centralized control device communicating with a first base station device and a second base station device, each of which forms one or more cells, and a terminal device to be connected to the cells, the centralized control device comprising:
an interference control unit configured to, in a case that interference between a cell formed by the first base station device and a cell formed by the second base station device is detected, suppress the interference by causing at least any one of the first base station device and the second base station device to change the formation of the cells and form a cell to which the terminal device is connectable based on a connection state prior to suppressing the interference in an area in which the interference has occurred.

7. An interference control method in a centralized control device communicating with a first base station device and a second base station device, each of which forms one or more cells, and a terminal device to be connected to the cells, the interference control method comprising:
in a case that interference between a cell formed by the first base station device and a cell formed by the second base station device is detected, suppressing the interference by causing at least any one of the first base station device and the second base station device to change the formation of the cells and form a cell to which the terminal device is connectable based on a connection state prior to suppressing the interference in an area in which the interference has occurred.

8. A non-transitory computer readable medium storing an interference control program for causing a computer of a centralized control device communicating with a first base station device and a second base station device, each of which forms one or more cells, and a terminal device to be connected to the cells to execute:
in a case that interference between a cell formed by the first base station device and a cell formed by the second base station device is detected, suppressing the interference by causing at least any one of the first base station device and the second base station device to change the formation of the cells and form a cell to which the terminal device is connectable based on a connection state prior to suppressing the interference in an area in which the interference has occurred.

9. The communication system according to claim 4,
wherein the interference control unit is configured to cancel the suspension of the formation of the cells based on the connection states of the plurality of terminal devices with respect to the cells.
